(19) United States
(12) Patent Application Publication
(10) Pub. No.: US 2010/0193343 A1
(43) Pub. Date: Aug. 5, 2010

(54) KEY SHEET AND METHOD FOR MANUFACTURING THE SAME

(76) Inventor: Minoru Yoshida, Niigata (JP)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/678,822

(22) PCT Filed: Oct. 3, 2008
(86) PCT No.: PCT/JP2008/068015

§ 371 Date: Mar. 18, 2010

(30) Foreign Application Priority Data
Oct. 5, 2007 (JP) 2007-261929

(51) Int. Cl. H01H 13/702; B29C 39/00

(52) U.S. Cl. 200/512; 700/197

(57) ABSTRACT

A key sheet 10 includes a key top 12, a pushing piece that mediates pressing force from the key top 12 to a metal dome 30, and a UV-curing resin sheet 20 that serves as a pushing pieces layer and includes a reinforcing rib 34 that improves rigidity of the key sheet 10. Further, an urethane sheet 10 and a PET sheet 18 are provided between the key top 12 and the UV-curing resin sheet 20 to serve as an intermediate layer. A method for manufacturing the key sheet 10 includes steps of integrally forming the UV-curing resin sheet 20 including the pushing pieces 28 and the reinforcing ribs 34 by filling a mold with a liquid UV-curing resin.

### BACKGROUND OF THE INVENTION

1. Field of the Invention

The present invention relates to a key sheet used in a push button switch in electric portable devices, such as mobile phones or cellular phones, personal digital assistances (PDA), and the like. In particular, the present invention relates to a thin key sheet having so-called narrow-pitch structure in which a plurality of key tops are provided to work as means for inputting user commands to push button switches and adjacent key tops are arranged at very narrow pitches, and relates to a method for manufacturing the same.

2. Description of the Related Arts

In electric portable devices, such as mobile phones (cellular phones), personal digital assistances (PDA), and the like, a key sheet is widely used as a part of push button switches. The key sheet is, in general, formed by a method in which key tops that are generally made of resin material such as polycarnobate and the like and a key base that is made of elastic material such as thermoplastic estramer and the like are connected with each other. Further, the key base is provided with pushing pieces on a bottom surface of the key base such that each of the pushing pieces would be arranged to face a corresponding one of the key tops. When one of the key tops will be pressed, the corresponding one of the pushing pieces moves to press one of metal domes that is provided on a printed circuit board to be arranged to face the pushing pieces into the inside of the printed circuit board. This causes a situation where the one of the metal domes would come in contact with a contact terminal so that the corresponding one of the push button switches would be turned on. In contrast to this, when the pressing force applied to one of the pushing pieces would be decreased to release the corresponding one of the metal domes from a contact terminal, the corresponding one of the push button switches would be turned off.

In recent years, there has been demanded to provide a key sheet that is configured to be thinner than a conventional one and has a structure simpler than that of a conventional one due to a tendency of reducing size of portable electronic devices. There is a known thin key sheet having so-called narrow-pitch structure in which a plurality of key tops are integrally arranged on an operation surface of a portable electronic device without any partition bridges (see, for example, the Japanese Patent Publication 1 and the Japanese Patent Publication 2).

For example, such the thin key sheet, as shown in the Japanese Patent Publication 2, is mainly made of elastic material such as silicon rubber and the like and has a shape of thin sheet. The key sheet is inset in an opening of the operation surface of the casing of a portable electronic device so that a peripheral portion of the key sheet is seated on an interior surface of the edge of the opening. Hence, when the casing to which the key sheet is installed would be arranged upright or be tilted, the weight of the key tops connected to the key base or the weight of the key base itself would induce deformation of the key sheet to cause the center of the key sheet to protrude outward from the operation surface of the casing.

Moreover, when the key sheet is in such the condition, pressing operation on one of the key tops results in an operational failure in the pressing switches due to a position mismatch as difference between positions of the one of the key tops and the metal dome, and a change for the worse in touching feelings during the pressing operation. Further, breakage of the key base and disconnection between the key base and the casing may occur when an amount of stretching deformation due to the deformation of the key sheet would have been exceeded.

There is one known structure of the key sheet for suppressing occurrence of the deformation of the key sheet. In such the known structure, the key base is made of silicon rubber using insert molding technique, and global rigidity of the key sheet has been improved by providing the key base with a thin reinforcing plate made of metal such as stainless steel and the like (for example, see Japanese Patent Laid-Open Publication No. 2007-115633).

Further, there is another known structure of the key sheet including a reinforcing plate having shape of lattice in a resin film in order to suppress occurrence of the deformation of the key sheet (for example, see Japanese Patent Laid-Open Publication No. 2004-319396).

In such the known structure of the key sheet, adhesive is generally used to fixedly connect the key tops made of resin to the key base made of silicon rubber (for example, see Japanese Patent Laid-Open Publication No 2004-319396).

In the above mentioned known key sheet that has the structure for suppressing occurrence of the deformation of the key sheet by providing the key sheet with the reinforcing plate made of metal such as stainless steel and the like, a reinforcing plate that is made of stainless steel and has a plurality of through holes, each of the through holes being arranged to face a corresponding one of key tops, has been integrally formed using insert molding technique in a key sheet made of silicon rubber. In general, such the reinforcing plate that is made of stainless steel and the like may be expensive, and there have been needs of redundant processes for manufacturing the key sheet including steps of forming a plurality of through holes in the metal plate and performing insert molding to form the key sheet integrally with the metal plate. Hence, the manufacturing cost of the key sheet has been increased because of need of these redundant processes.

Further, in the above-mentioned another known key sheet that has the structure for suppressing occurrence of the deformation of the key sheet by providing the resin film with the reinforcing plate having shape of lattice, the resin film has a plurality of through holes and a plurality of reinforcing members made of resin. Each of the through holes should be arranged to face a corresponding one of key tops and each of bars of the key tops made of the resin film should be arranged to face one of reinforcing members made of resin. Hence, in general, there have been needs of redundant processes for manufacturing the key sheet.

Further, in the known key sheet having key tops which are fixedly connected on a sheet made of silicon rubber, so-called material breakage may have occurred. That is, the key tops would not be exfoliated from the key sheet due to breakage of adhesive contact layer, but silicon rubber of which the key sheet is made would be broken while the key tops are maintained to be fixedly connected to the key sheet, when the key sheet and the key tops would be subjected to excessive force to be pulled up and to be exfoliated from the key sheet, respectively, during manufacturing or during use, or when the key tops would be processed to be separated from the key base during recycling of the key sheet. Because of this, it may have become difficult to repair the key sheet during manufacturing or during use. Further, during recycling of the key sheet because separation between the key tops and the key base has become to be difficult, recycling process has not been carried out easily.

The present invention has been made taking in consideration of the above-mentioned situations. It is an object of the present invention to provide a thin key sheet that has an improved sheet rigidity to prevent the key sheet from being deformed easily and has a simple structure in which, even when the casing of a portable electric device which is provided with the key sheet is arranged upright or is tilted, the key tops can be maintained to be fixedly connected to the key sheet. Further, it is an object of the present invention to provide a thin key sheet in which, even when the key tops would be subjected to excessive force to be exfoliated from the key sheet during manufacturing, during use, or during recycling of the key sheet, material breakage can be prevented from occurring. Further, it is also an object of the present invention to provide a method for manufacturing such the key sheet.

### SUMMARY OF THE INVENTION

A key sheet according to the present invention has employed the following techniques to solve the above-mentioned problems.

The present invention provides a key sheet used in a push button switch in an electric portable device, the key sheet including a key top, and a key base that is made of photocuring resin and is provided with a reinforcing rib to improve rigidity of the key sheet, the key base mediating pressing force from the key top to a metal dome.

In the key sheet according to the present invention, there is provided the key base that is made of photocuring resin with the reinforcing rib to improve rigidity of the key sheet.

A method for manufacturing a key sheet according to the present invention has employed the following techniques to solve the above-mentioned problems.

The present invention provides a method for manufacturing a key sheet used in a push button switch in an electric portable device, the method including a step of integrally forming a key base which further includes a step of filling a mold with liquid photocuring resin, the key base having a pushing piece that mediates the pressing force from the key top to the metal dome and a reinforcing rib that improves rigidity of the key sheet.

In the method according to the present invention, the pushing piece that mediates the pressing force from the key top to the metal dome and the reinforcing rib that works to improve rigidity of the key sheet are formed together in the same key base in the same manufacturing step.

### BRIEF DESCRIPTION OF THE DRAWINGS

FIG. 1 is a schematic perspective view showing an embodiment of a mobile phone that is provided with a key sheet 10 according to the present invention on an operation surface of the mobile phone;

FIG. 2 is a cross-sectional view showing the embodiment of the key sheet 10 according to the present invention taken along line A-A drawn on the figure of the key sheet 10 of the mobile phone 100 in FIG. 1;

FIG. 3 is an explored perspective view showing the key sheet 10 according to the present invention as viewed from above (from a side near key tops 12);

FIG. 4 is an explored perspective view showing the key sheet 10 according to the present invention as viewed from below (from a side near a UV-curing resin 20);

FIG. 5 (A) is a flowchart illustrating a method for manufacturing the key sheet 10 according to the present invention; and

FIG. 5(B) is an illustration explaining processes of manufacturing the key sheet 10, each of the processes being defined by corresponding one of steps included in the flowchart shown in FIG. 5(A).

### DETAILED DESCRIPTION OF THE PREFERRED EMBODIMENTS

### General Description

A key sheet according to one embodiment of the present invention has employed the following techniques to solve the above mentioned problems.

The present invention provides a key sheet used in a pressing switch in an electric portable device, the key sheet including a key top, and a key base that is made of photocuring resin and is provided with a reinforcing rib to improve rigidity of the key sheet, wherein the key base mediates pressing force from the key top to a metal dome.

In the key sheet according to the present invention, there is provided the key base that is made of photocuring resin with the reinforcing rib to improve rigidity of the key sheet.

A key sheet according to another embodiment of the present invention is characterized by further including an intermediate layer that has a layer of urethane and is provided between the key top and the key base.

According to the present invention, there is provided the intermediate layer that has the layer made of urethane and is provided between the key top and the key base, so that the pressing force applied to the key top is transmitted to the key base via the intermediate layer having the layer made of urethane, that is, elastic material. Hence, the layer of urethane effectively absorbs sound or noise generated by deformation of the key sheet caused during pressing operation in the intermediate layer or the key base. Further, because tear strength of urethane is greater than that of silicon rubber, occurrence risk for material breakage can be reduced when the key sheet and the key tops would be subjected to applied force to be pulled up and to be exfoliated from the key sheet, respectively.

A key sheet according to another embodiment of the present invention is the key base which is provided with a pushing piece to mediate the pressing force from the key top to the metal dome and is formed using an integral molding technique.

According to the present invention, because the key base is provided with the pushing piece to mediate the pressing force from the key top to the metal dome and is formed using an integral molding technique, it is possible that two members which has difference purposes and objects each other, that is, the pushing piece that mediates the pressing force from the key top to the metal dome and the reinforcing rib that works to improve rigidity of the key sheet, are formed together in the same key base in the same manufacturing step.

For example, a method for integrally forming the key base including the pushing force and the reinforcing rib is exemplified by that including a step of dropping photocuring resin such as liquid UV-curing resin into a mold. Further, a printing technique such as photogravure technique can be utilized to form the key base.

A key sheet according to another embodiment of the present invention is characterized in that, the key base has a shape in which the pushing piece and the reinforcing rib are protruded in the same direction from the same surface.

According to the present, invention, because the pushing piece and the reinforcing rib are protruded in the same direction from the same surface, they are arranged to be overlapped in a side elevational view of the key base. Hence, in comparison with the case where the pushing piece and the reinforcing rib are protruded in the opposite directions each other from a two-sided layer, it is possible to increase sheet rigidity of the key sheet while thickness of the key sheet is not needed to be increased and therefore the key sheet keeps being thin.

A key sheet according to another embodiment of the present invention is characterized in that, the height of the reinforcing rib is equal to or shorter than that of the pushing piece.

According to the present invention, because the height of the reinforcing rib is equal to or shorter than that of the pushing piece, the thickness of the key base having the pushing piece and the reinforcing rib is determined by that of the pushing piece and is not increased due to formation of the reinforcing rib in the key base. Hence, it is possible to increase sheet rigidity of the key sheet while thickness of the key sheet is not needed to be increased and therefore the key sheet keeps being thin.

A key sheet according to another embodiment of the present invention is characterized in that, the reinforcing rib is formed in shape of lattice.

According to the present invention, because the reinforcing rib is formed in shape of lattice, rigidity of the key base is generally increased. Hence, global rigidity of the key sheet can be increased.

A method for manufacturing a key sheet according to the present invention has employed the following techniques to solve the above-mentioned problems.

The present invention provides a method for manufacturing a key sheet used in a push button switch in an electric portable device, the method including a step of integrally forming a key base which further includes a step of filling a mold with liquid photocuring resin, the key base having a pushing piece that mediates the pressing force from the key top to the metal dome and a reinforcing rib that improves rigidity of the key sheet.

In the method according to the present invention, the pushing piece that mediates the pressing force from the key top to the metal dome and the reinforcing rib that works to improve rigidity of the key sheet are formed together in the same key base in the same manufacturing step.

### ADVANTAGES OF THE PRESENT INVENTION

According to the present invention, it is possible the key sheet having improved global rigidity while the key sheet keeps having a simple structure, and hence even when the casing which is provided with the key sheet would be arranged upright or is tilted, the center of the key sheet can be prevented from protruding outward from the operation surface of the casing. Further, when the key sheet and the key tops would be subjected to excessive force to be pulled up and to be exfoliated from the key sheet, respectively, it is possible to prevent material breakage from occurring. Moreover, because it is configured to have a simple structure, the key sheet according to the present invention can be manufactured easily and at a low cost.

### DESCRIPTION OF THE ILLUSTRATED EMBODIMENTS

In the following, embodiments of a key sheet and a method for manufacturing the same according to the present invention will be described with reference with the accompanying drawings.

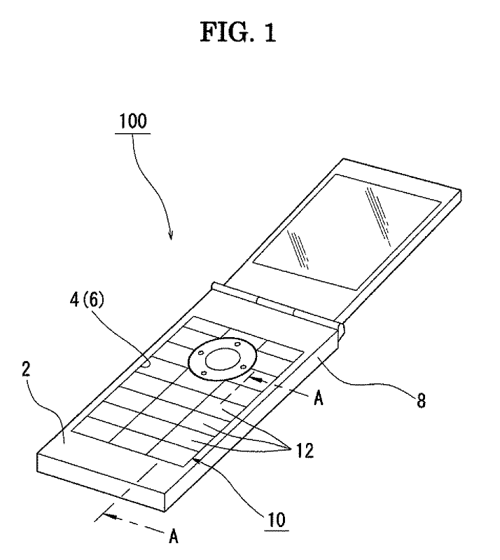

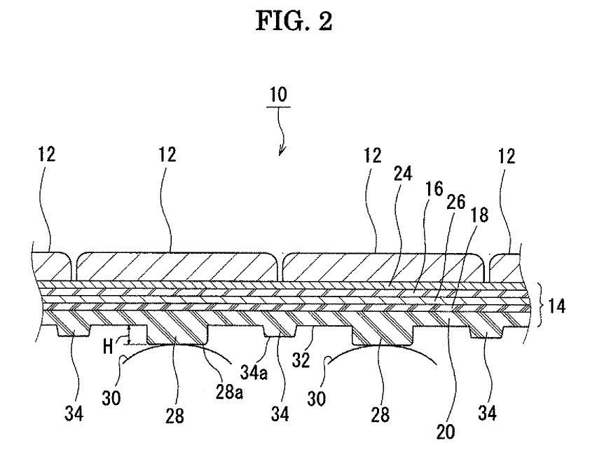

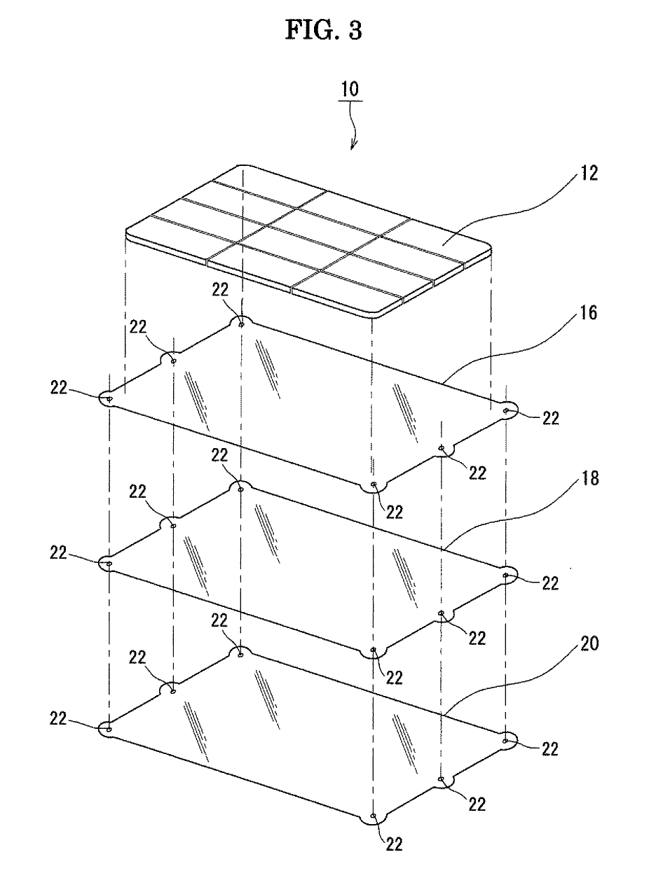

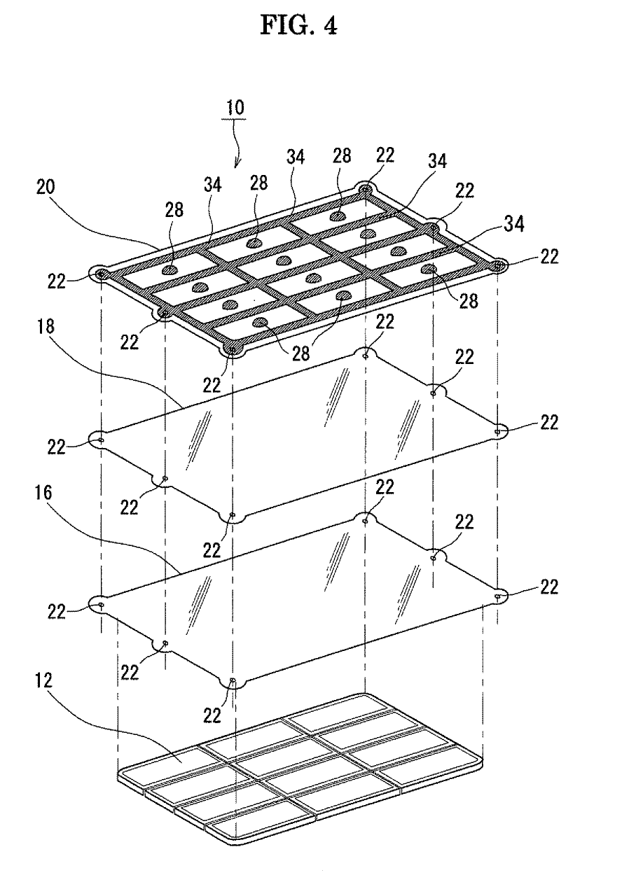

FIG. 1 is a schematic perspective view showing an embodiment of a mobile phone that is provided with a key sheet 10 according to the present invention on an operation surface of the mobile phone. FIG. 2 is a cross-sectional view showing the embodiment of the key sheet 10 according to the present invention taken along line A-A drawn on the figure of the key sheet 10 of the mobile phone 100 in FIG. 1. FIG. 3 is an explored perspective view showing the key sheet 10 according to the present invention as viewed from above (from a side near key tops 12), and FIG. 4 is an explored perspective view showing the key sheet 10 according to the present invention as viewed from below (from a side near a UV-curing resin 20).

As shown in FIG. 1, a key sheet 10 according to the present invention has a plurality of key tops 12 made of resin on the operation surface 2 of the mobile phone 100 such that the plurality of the key tops 12 are exposed to the operation surface 2. An individual function for operating the mobile phone 100 is assigned to each of the key tops 12, and is indicated by a corresponding one of characters, symbols, figures, numerals and the like which is printed on each of the key tops 12, though not illustrated in FIG. 1. Adjacent key tops 12 are arranged at so-called very narrow pitches, for example, at regular intervals of 0.2 mm (a value of the pitches is not limited to this value) or less.

As shown in FIGS. 2 and 3, the key sheet 10 is comprised of the plurality of the key tops 12 having shape of a rectangular thin plate and a base portion 14 which has shape of a thin plate and on which the plurality of the key tops 12 are mounted. The base portion 14 is comprised of a translucent urethane sheet 16 constituting a urethane sheet, a translucent polyethylene terephthalate (PET) sheet 18 constituting a member of an intermediate layer, and a UV-curing resin sheet 20 constituting a pushing pieces layer (a key base). The translucent urethane sheet 16, the translucent PET sheet 18, and UV-curing resin sheet 20 are layered in the vertical direction in this order from top to bottom.

As shown in FIG. 3, engagement holes 22 are provided at four corners and two short side edges of each sheet 16, 18, 20. When the sheets 16, 18, 20 are layered, positions of the engagement holes 22 coincide with each others and an engaged pin (not shown) is provided in an interior 6 below an opening 4 of the mobile phone 100 to be engaged with the engagement holes 22 so that the key sheet 10 is fixedly arranged in the mobile phone 100.

The key tops 12 are secured to the urethane sheet 16 via a adhesive contact layer 24, and the urethane sheet and the PET sheet 18 are laminated together via a adhesive contact layer 26 which is translucent and slightly adhesive. Hence, the key tops 12, the urethane sheet 16, and the PET sheet 18 can be integrated into one component.

Because it is relatively soft and has elasticity, the urethane sheet 16 is used to increase adhesion of the urethane sheet 16 to the key tops 12 mounted on the urethane sheet 16 and to improve touching feelings during the pressing operation to be more comfortable. Hence, because of structure in which the key tops 12 is fixedly connected to the whole of an upper surface of the urethane sheet 16 via the adhesive contact layer 24, the key tops 12 cannot easily be separated from the urethane sheet 16 even when the key tops 12 would be subjected to an external force to be exfoliated from the urethane sheet 16. In contrast to this case, when an excess tensile force would be applied, because the tear strength and the tensile strength of urethane are greater than and exceed those of silicon rubber, it can become difficult to simultaneously break the key tops 12 and the urethane sheet 16 and at the same time can become easy to separated the key tops 12 from the urethane sheet 16 due to breakage of the adhesive contact layer 24. Thus, because the key tops 12 would be separated from the urethane sheet 16 due to breakage of the adhesive contact layer 24 when the key tops 12 is subjected to the excess tensile force, it is possible to reduce occurrence of so-called material breakage in comparison with a case where the key tops 12 are fixedly connected to a sheet of silicon rubber.

Because the urethane sheet 16 is connected to the PET sheet 18, the urethane sheet 16 effectively absorbs noisy sound generated by deformation of the PET sheet 18 caused during pressing operation. Hence, the urethane sheet 16 has a function of preventing an operator from noticing generation of the noisy sound.

The PET sheet 18 is provided between the urethane sheet 20 and the UV-curing resin sheet 16 to mainly ensure the key sheet 10 has sufficient rigidity, and can be deformed to follow change or changes in size or sizes of at least one of the urethane sheet 16 and the UV-curing resin sheet 20 quickly.

When the base portion 14 consists of a single layer made of urethane, repetitive pressing operations for pressing the key tops 12 may influence a printed surface, for example, the printed surface below the key tops 12 and a surface of the base portion 14 may be rubbed together. One reason of this ascribed to a fact that urethane is a soft material. Because the base portion 14 is formed as a layered structure being comprised of the urethane sheet 16 and the PET sheet 18 made of hard resin, it is possible to prevent the printed surface from being subjected to the influence.

As shown in FIG. 2, the UV-curing resin sheet 20 has a bottom surface 32 on which pushing pieces 28 are provided to be protruded from the bottom surface 32 and are arranged such that each of the pushing pieces 28 would face a corresponding one of the key tops. Further, each of the pushing pieces 28 abuts with one of metal domes 30 provided on a printed circuit board (not shown) which is disposed below the UV-curing resin sheet 20 via a gap space. When one of the key tops 12 would be employed in pressing operation, a corresponding area of the base portion 14 is deformed in downward direction so that the corresponding one of the pushing pieces 28 located just below the one of the key tops 12 moves to press and deform one of the metal domes 30. This causes a situation where the one of the metal domes would come in contact with a contact terminal (not shown) so that the corresponding one of the push button switches is to be turned on. In contrast to this when the pressing force to one of the pushing pieces 28 would be decreased to release the corresponding one of the metal domes 30 from the contact terminal, the corresponding one of the push button switches is to be turned off.

On the bottom surface 32 of the UV-curing resin sheet 20 on which the pushing pieces 28 are also provided, there are provided reinforcing ribs 34 which are protruded to be a substantially convex-shaped cross section and which are arranged below narrow clearances formed between adjacent key tops 12. Each of the reinforcing ribs 34 is formed to have the height in the vertical direction equal to or shorter than protuberant height H of the corresponding one of the pushing pieces 28. As shown in FIG. 2, the height of the reinforcing rib 34 in the vertical direction is defined as a distance between the bottom surface 32 of the UV-curing resin sheet 20 and a top 34a of the reinforcing rib 34 in the vertical direction, and the protuberant height H of one of the pushing pieces 28 is defined as a distance between the bottom surface 32 and a top 28a of the one of the pushing pieces 28 in the vertical direction.

As discussed above, because the reinforcing rib 34 and the pushing pieces 28 are provided on the same surface, it is possible to reduce the thickness of the UV-curing resin sheet 20 constituting the pushing pieces layer. Further, because each of the reinforcing ribs 34 is formed to have height equal to or shorter than the protuberant height H of the corresponding one of the pushing pieces 28, it is possible to increase global rigidity of the sheet while thickness of the UV-curing resin sheet 20 is not needed to be increased.

As shown in an explored perspective view of FIG. 4 showing the key sheet 10 as viewed from below (from a side near a UV-curing resin 20), the reinforcing ribs 34 are arranged on the bottom surface 32 of the UV-curing resin sheet 20 below the boundary lines of the key tops 12 to form a lattice structure. Hence, because the reinforcing ribs 34 having the substantially convex-shaped cross section are arranged to form a rectangular lattice whose edges are parallel to the ordinate axis or the abscissa axis in the plate-shaped UV-curing resin sheet 20, it is possible to improve global rigidity of the UV-curing resin sheet 20 effectively. As a result of this, it is therefore possible to improve global rigidity of the key sheet 10 so as to prevent deformation of the key sheet 10 from occurring.

In such the structure, when one of the key tops 12 would be employed in pressing operation, the UV-curing resin sheet 20 is deformed accompanying bends of thin portions which are formed between the pushing pieces 28 and the reinforcing ribs 34 and have relatively small rigidity, and then the corresponding one of the pushing pieces 28 located just below the one of the key tops 12 moves downward to press one of the metal dome 30. Hence, because the reinforcing ribs 34 are arranged to from a lattice and each of the reinforcing ribs 34 is positioned at one of peripheral edges of the one of the key tops 12, when the one of the key tops 12 would be employed in pressing operation, the reinforcing ribs 34 positioned at the one of peripheral edges of the one of the key tops 12 serve as fulcrums and hence do not shift their positions. Therefore, because the UV-curing resin sheet 20 can be deformed to move the corresponding one of the pushing pieces 28 downward without affecting any behaviors of adjacent key tops 12, it is possible to prevent an operation failure from occurring.

The effects and operations of the key sheet 10 having the above mentioned structure will be described.

When the mobile phone 100 in which the key sheet 10 according to the present invention is installed would be tilted and inverted, the operation surface 2 of a casing 8 faces downward so that the weight of the key sheet 10 itself tends to induce elongation and deformation of the key sheet 10 downward. However, because the reinforcing ribs 34 are arranged to form the lattice on the UV-curing resin sheet 20 and have substantially convex-shaped cross sections, so that the reinforcing ribs 34 work to improve global rigidity of the key sheet 10 and thus to keep a surface of the key sheet 10 exposed to the operation surface 2 flat, it is possible to prevent deformation of the key sheet 10 from easily occurring. Even when the deformation of the key sheet 10 would occur, an amount of the deformation may not increase so that it would prevent breakage of the key sheet 10 and disconnection between the key sheet 10 and the casing 8 from occurring.

In the extremely special case where the key sheet 10 and the key tops 12 may be subjected to excessive force to be pulled up and to be exfoliated from the operation surface 2, respectively, the key tops 12 would be exfoliated from the urethane sheet 16 due to breakage of the adhesive contact layer 24. A reason of this would be ascribed to a fact that the urethane sheet 16 has tear strength and tensile strength greater than those of a conventional sheet made of silicon rubber. Therefore, because capability of the urethane sheet 16 resisting occurrence of so-called material breakage is improved, crack phenomena of the urethane sheet 16 can be suppressed to occur.

### Embodiment of the Method for Manufacturing the Key Sheet

Next, referring to the drawings, one embodiment of a method for manufacturing the key sheet 10 according to the present invention will be described.

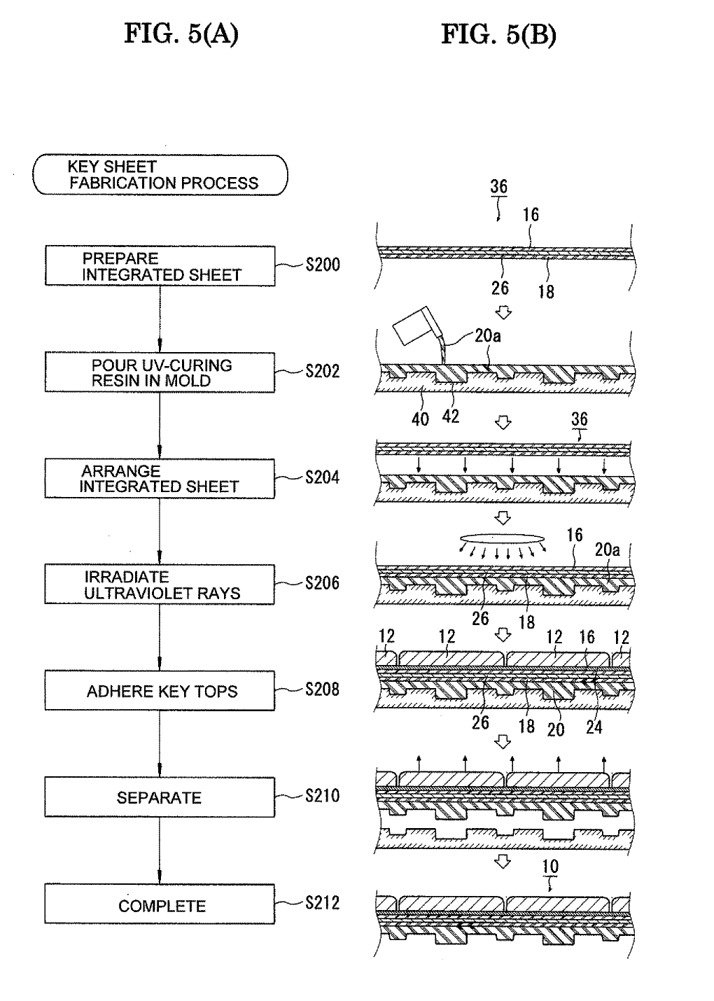

FIG. 5(A) shown in a left column in a drawing sheet is a flowchart illustrating a method for manufacturing the key sheet 10 according to the present invention, and FIG. 5(B) shown in a right column in the drawing sheet is an illustration explaining processes of manufacturing the key sheet 10, each of the processes being defined by corresponding one of steps included in the flowchart shown in FIG. 5(A).

As shown in FIGS. 5(A) and 5(B), first, in step S200, the PET sheet 18 and the urethane sheet 16 are laminated together via a adhesive contact layer 26 which is translucent and slightly adhesive to form an integrated sheet 36 (S200).

Next, in step S202, a liquid UV-curing resin 20a drops to a mold 40 to fill the mold 40 with the liquid UV-curing resin 20a (S202). It would be noted that a side wall 42 at the bottom of the mold 40 includes convex and concave shaped surface which are formed to determine shapes of the pushing pieces 28 and the reinforcing ribs 34 and on which the liquid UV-curing resin 20a is dropped.

Then, a surface of the liquid UV-curing resin 20a with which the mold 40 is filled and a surface of the integrated sheet 36 formed in step S200 come closely in contact with each other (S204). To perform this step, the integrated sheet 36 is disposed such that a surface of the PET sheet 18 comes to closely in contact with the surface of the liquid UV-curing resin 20a and a surface of the urethane sheet 16 is arranged to face upward (a side surface on which the key tops 12 to be disposed). Further, in this step, a pressure can be applied to the UV-curing resin 20a and the integrated sheet 36 in the thickness direction to adjust thickness of the UV-curing resin 20a to have a desired value.

Next, in step S206, the liquid UV-curing resin 20a with which the mold 40 is filled is exposed to ultraviolet rays, i.e., UV rays, emitted from the direction of the urethane sheet 16 (S206). In such the situation, the ultraviolet rays is transmitted through the urethane sheet and the PET sheet 18 to reach the liquid UV-curing resin 20a, so that the liquid UV-curing resin 20a is acted by the ultraviolet rays to be cured. Therefore, the pushing pieces 28 and the reinforcing ribs 34 are integrally formed in the UV-curing resin sheet 20 serving as the pushing pieces layer (the key base). In this process, the liquid UV-curing resin 20a and the integrated sheet 36 are integrally connected with each other to complete formation of the base portion 14 after the UV-curing resin 20a has cured.

After all of the UV-curing resin sheet 20, the PET sheet 18, and the urethane sheet 16 are integrated, the key tops 12 are attached to the urethane sheet 16 (S208) in step S208. Then, the key sheet 10 is removed from the mold 40 (S210) in step 210 so that the key sheet 10 according to the present invention can be obtained (S212). Further, process in which the key tops 12 is attached to the urethane sheet 16 is not limited to be performed on the timing of step S208 as described above, and it would be allowed to be performed just after the PET sheet 18 and the urethane sheet 16 have been integrally formed or before the UV-curing resin sheet 20 is not finished to be formed.

As discussed above, in the method for manufacturing the key sheet 10 according to the present invention, the mold 40 having the convex and concave shaped surface which are formed to determine shapes of the pushing pieces 28 and the reinforcing ribs 34 is filled with the liquid UV-curing resin 20a. Then, the integrated sheet 36 is disposed on the surface of the liquid UV-curing resin 20a, and the UV rays are emitted from the direction of the urethane sheet 16 toward the UV-curing resin 20a to form the UV-curing resin sheet 20 serving as the pushing pieces layer. Thus, it is possible that the pushing pieces 28 and the reinforcing ribs 34 are integrally formed in the pushing pieces layer in the single-step process. In the method for manufacturing the key sheet 10 according to the present invention, because it is not necessary to perform a process for providing with the reinforcing ribs 34 in addition to a process for forming the pushing pieces 28, two members, i.e., the pushing pieces 28 and the reinforcing ribs 34 which would be provided for different uses and have different functions, are simultaneously formed in a single-step process so that manufacturing efficiency can be improved. Therefore, in the method for manufacturing the key sheet 10 according to the present invention, it is possible to manufacture the key sheet in which global rigidity is simply and effectively improved.

In the above mentioned embodiment of the method for manufacturing the key sheet 10, instead of performing processes in which the liquid UV-curing resin 20a drops to a mold 40 to form the pushing pieces 28 and the reinforcing ribs 34, a smearing technique or a printing technique, for example, a photogravure technique can be utilized to form the pushing pieces 28 and the reinforcing ribs 34. In this case, concave portions which are designed to be fitted to shapes of the pushing pieces 28 and the reinforcing ribs 34 are formed in a photogravure plate, and the liquid UV-curing resin 20a is put on the concave portions. Next, the liquid UV-curing resin 20a is transferred from the photogravure plate to the integrated sheet 36. Then, the liquid UV-curing resin 20a is acted by the ultraviolet rays to be cured so that the pushing pieces 28 and the reinforcing ribs 34 are integrally formed in the single-step process. This allows the pushing pieces 28 and the reinforcing ribs 34 to be integrally formed in the pushing pieces layer.

Further, in the above mentioned embodiments of the method for manufacturing the key sheet 10, instead of performing processes in which the UV rays are emitted from the direction of the urethane sheet 16, the side wall 42 of the mold 40 can be made of translucent material or light guide material and a UV light source that is located inside the side wall 42 or outside the mold 42 may emit UV rays toward the UV-curing resin 20a from the direction of the side wall 42 to cure the UV-curing resin 20a. These processes can obtain the same effects and operations with those of the previous embodiments, that is, the pushing pieces 28 and the reinforcing ribs 34 are integrally formed in the pushing pieces layer. Further, it would be allowed that the urethane sheet 16, the adhesive contact layer 26 which is slightly adhesive, and the PET sheet 18 can be made of non-translucent materials.

In the above mentioned embodiments, the reinforcing ribs 34 are arranged to form a rectangular lattice structure, and thereby can accommodate every peripheral contour of the key tops 12 having a shape of rectangular. In the cases where every peripheral contour of the key tops 12 has shape of polygon such as triangle, hexagon, and the like, circle, ellipse, and other geometries, the structure of the reinforcing ribs 34 is not limited to the rectangular lattice structure, and can be allowed to have a triangular lattice structure, hexagonal (honeycomb) lattice structure, a zigzag lattice structure, wavy lattice structure and other suitable structures that accommodate the peripheral contour of the key tops 12. When the reinforcing ribs 34 have such the arrangement, it is possible to obtain the same effects and operations according to the previous embodiments of the present invention so as to improve global rigidity of the key sheet 10.

Further, it is allowed that there is a partial region. For example, it is allowed that the reinforcing ribs 34 are arranged in a lattice structure in a central region on the sheet 20, and the reinforcing ribs 34 is removed from a peripheral region on the sheet 20 that is fixedly connected to the casing. In such the arrangement of the reinforcing ribs 34, it is possible to obtain the same effects and operations according to the previous embodiments of the present invention so as to improve global rigidity of the key sheet 10.

In the above mentioned embodiments, values of thickness of sheets which constitute the base portion 14 can be exemplified by, a value of thickness of the urethane sheet 16 be about 50 μm, that of the adhesive contact layer 24 may be about 30 μm, that of the adhesive contact layer 26 which is slightly adhesive be about 25 μm, that of the PET sheet 18 be about 25 μm, that of the UV-curing resin sheet 20 be about 10 μm, and a value of the protuberant height H of the pushing pieces 28 be about 250 μm. When these dimensions are accepted, it is possible to obtain the same effects and operations according to the previous embodiments of the present invention so as to improve global rigidity of the key sheet 10. In the above example, a total thickness of the key sheet 20 wherein the key tops 12 is not included can be about 390 μm which is identical with thickness of the base portion 14. Hence, it is possible to improve global rigidity of the key sheet 10 and to realize the key sheet 10 is very thin. In particular, when a value of thickness of the key tops 12 is suppressed to be about 600 μm (0.6 mm) in this case, the total thickness of the key sheet 20 can be about 990 μm so as to be less than 1.0 mm. Therefore, it is possible to realize the key sheet 10 which is very thin and has improved global rigidity.

In the above mentioned embodiments, it has been explained that the urethane sheet 16 serves as the urethane layer that is member of the intermediate layer. However, the urethane layer is not limited to the urethane sheet 16, but it would be allowed that any sheet which is made of material or compound having sufficient tear strength and sufficient tensile strength for preventing the material breakage from occurring when the key tops 12 would be exfoliated and including a urethane compound suitable for fixedly connecting the resin-made key tops 12 to the sheet. Therefore, even when any one of the material or compound would be used to make the urethane layer, it is possible to obtain the same effects and operations according to the previous embodiments of the present invention so as to improve global rigidity of the key sheet 10.

In the above mentioned embodiments, instead of using the PET sheet 18 as a member of the intermediate layer, a sheet made of material which has suitable rigidity and flexibility can be used. In this case, any resin or compound, for example, PET resin, polycarbonate (PC) resin, polybutylene terephthalate (PBT) resin, nylon resin, polypropylene (PP) resin, fluoride (PFA/FEP) resin, and polyolefin resin, can be used as the member of the intermediate layer. Even in such the configuration, it is possible to obtain the same effects and operations according to the previous embodiments of the present invention so as to improve global rigidity of the key sheet 10.

In the above mentioned embodiments, a UV-curing resin used in the UV-curing resin sheet 20 serving as the pushing pieces layer (the key base) can be realized by any one of UV-curing resins exemplified by urethane acrylate resin, epoxy acrylate resin, and polyester acrylate resin. Further, it has been explained that the UV-curing resin sheet 20 serves as the pushing pieces layer. However, the pushing pieces layer is not limited one made of UV-curing resin, but can be constituted by a sheet made of other light-curing resin. Even in such the configurations, it is possible to obtain the same effects and operations according to the previous embodiments of the present invention.

In the above mentioned embodiments, it has been explained that the pushing pieces are formed in the UV-curing resin sheet 20 which serves as the key base. However, in the case where the key sheet according to the present invention is used together with either metal domes provided on a printed circuit board or push button switches in which pushing pieces are provided on a dome sheet to which metal domes are secured, there is no need to form the pushing pieces in the UV-curing resin sheet 20 which serves as the key base to obtain the same effects and operations according to the previous embodiments of the present invention.

In the above mentioned embodiments, the adhesive contact layer 24 which fixedly connect the key tops 12 to the urethane sheet 16 can be formed from heat cure adhesive such as hot melt adhesive or other adhesive suitable for connecting resin member and urethane member together. In such the case, chloroprene rubber adhesive, NBR adhesive, natural rubber adhesive, urethane adhesive, cyanoacrylate adhesive, polyester adhesive, polyolefin adhesive, UV adhesive, and instant adhesive are exemplified as an adhesive from which the adhesive contact layer 24 can be formed. Even in such the configurations, it is possible to obtain the same effects and operations according to the previous embodiments of the present invention.

As described above, the key sheet 10 according to the present invention includes the reinforcing ribs 34 which have the substantially concave-shaped cross section and are arranged at regions where local rigidity would be reduced because there are no partition bridges, so that global rigidity of the key sheet 10 can be improved. Further, in the method for manufacturing the key sheet 10 according to the present invention, the pushing pieces 28 and the reinforcing ribs 34 can be integrally formed in the same pushing pieces layer (the key base) in the single-step process. Therefore, it is possible to manufacture the key sheet in which global rigidity is simply and effectively improved.

What is claimed is:

1. A key sheet used in a pressing switch in an electric portable device, comprising:
a key top; and
a key base that is made of photocuring resin and is provided with a reinforcing rib to improve rigidity of the key sheet, the key base mediating pressing force from the key top to a metal dome.

2. The key sheet according to claim 1, further comprising:
an intermediate layer that has a layer of urethane and is provided between the key top and the key base.

3. The key sheet according to claim 1, wherein the key base is provided with a pushing piece to mediate the pressing force from the key top to the metal dome and is formed using an integral molding technique.

4. The key sheet according to claim 3, wherein the key base has a shape in which the pushing piece and the reinforcing rib are protruded in the same direction from the same surface.

5. The key sheet according to claim 4, wherein a height of the reinforcing rib is equal to or shorter than that of the pushing piece.

6. The key sheet according to claim 1, wherein the reinforcing rib is formed in shape of lattice.

7. A method for manufacturing a key sheet used in a pressing switch in an electric portable device, comprising a step of:
integrally forming a key base which further includes a step of filling a mold with liquid photocuring resin, the key base having a pushing piece that mediates the pressing force from the key top to the metal dome and a reinforcing rib that improves rigidity of the key sheet.
